(19) United States
(12) Patent Application Publication
(10) Pub. No.: US 2005/0114312 A1
(43) Pub. Date: May 26, 2005

(54) Efficient string searches using numeric keypad

(75) Inventor: Leonard Ciprian Mosescu, Seattle, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/722,987

(22) Filed: Nov. 26, 2003

(51) Int. Cl. G05D 1/00

(52) U.S. Cl. 707/3

(57) ABSTRACT

Contacts are stored in memory on a mobile device with a limited input device containing input points. Each input point corresponds to a subset of the alphabet. For each contact, a string comprising characters representing the input points that correspond to the letters of the alphabet contained in the name of the contact is generated and saved with the contact in the memory. When a user desires to retrieve a contact, the user presses the input point that corresponds to the subset of the alphabet containing the first letter in the name of that contact. A prefix search for the character representing that input point is performed on the saved generated strings. Any contacts containing a matching string are then presented to the user.

### FIELD OF THE INVENTION

This invention relates in general to the field of computer string searches. More particularly, this invention relates to string searches using a limited input device.

### BACKGROUND OF THE INVENTION

A typical portable device, such as a cell phone, has limited input capabilities due to the desire to keep the device small. It is very uncommon to have a full keyboard. Many portable devices have only a twelve key numeric keypad. This limitation requires the application developer to design the user interface to allow the user to input the full range of numeric strings on a limited keypad. The common solution is to associate letter groups to each digit key. For example, key two is associated with the letters a through c, key three is associated with the letters d through f, and so on. A similar solution used in some pen input devices associates icons with groups of letters on the screen. The user then selects a particular letter by selecting the icon associated with the group containing that letter.

Typically a portable device user will store records containing various strings such as names and phone numbers in a contacts database in the device. Often the user will try to search or filter the database by particular strings in the record. It is desirable for the application to search or filter the records by an input string as the user enters the beginning of the string from left to right.

One of the requirements of such an application is that the search times, and therefore the user interface update times, should be small enough to match the user key input speed without requiring the user to wait for the updates to complete. The difficulty is that the user does not enter the real prefix of the string he is searching for; instead, his input consists of a key selection which translates into a set of possible characters. Thus, for example, when the user presses key 2, it is unclear whether the user means to select a, b, or c.

The common approach performs a linear scan through the records and has O(n) time complexity for each character searched, where n is the total number of records in the database. If m is the number of characters in the set that corresponds to the key that is pressed, then the end complexity will be O(n×m), which is unacceptably slow in terms of user interface update times. For example, if the user pressed key two, a prefix search would be done on a, then b, then c.

Another solution is to perform searches on each character contained in the group in a separate thread and update the user interface in parallel with the searches. However, this solution has its own limitations including additional implementation complexity and processing costs.

In view of the foregoing, there is a need for a method of searching and storing contact data in mobile devices that overcome the complexity and inefficiency of the prior art.

### SUMMARY OF THE INVENTION

The present invention provides a mechanism for efficient string searches on a mobile device using a limited keypad. According to one embodiment, it is desirable to store a contact name and additional contact information in a database residing on a mobile device with a limited keypad. Typically this keypad will have multiple letters of the alphabet assigned to each key. The name is entered in a mobile device, by a user for example. A new string is generated by substituting each letter of the entered name with a character representing the key on the keypad associated with that letter. The name, the generated string, and the additional contact information (entered separately by the user, for example) are then stored in the device.

It is later desirable to retrieve a contact name and contact information from the database. The user presses a key on the limited keypad assigned to the subset of the alphabet containing the first letter of the contact name that the user desires to locate. A prefix search of the single character representing the pressed key is performed on the stored generated strings. The matching entries are then presented to the user by displaying, for example, the contact name stored with each matching generated string. The user either selects the desired name from the presented list of contact names, and the name and associated contact information is then displayed or otherwise presented, or the user may press another key on the limited keypad assigned to the subset of the alphabet containing the next letter of the contact name that the user desires to locate. If a new key is pressed, a prefix search of the characters representing the keys pressed so far is then performed on the stored generated strings. The matching entries are again displayed and the process continues until the desired name is located, or it is determined that the name is not in the database.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is an example of a keypad device useful to describe aspects of the invention;

FIG. 3 is a sample table for associating characters on a keypad with subsets of the alphabet in accordance with the present invention;

FIG. 4 is a sample table for storage of records or contacts in accordance with the present invention;

FIG. 5 is a flow diagram of an exemplary method of submitting a record or string in accordance with the present invention;

FIG. 6 is a storage diagram useful to describe aspects of the present invention;

FIG. 7 is a flow diagram of an exemplary method of retrieving a record or string in accordance with the present invention; and

FIG. 8 is a retrieval diagram useful to describe aspects of the present invention.

### DETAILED DESCRIPTION OF PREFERRED EMBODIMENTS

Overview

The present invention is directed to efficient string searching on a database of a mobile device wherein search terms are input using a limited input device. The exemplary systems and methods described herein are more efficient than current techniques and keeps the number of searches on the storage device to a minimum.

A mobile device contains an input device with a number of input points. Each input point corresponds to a unique subset of letters in an alphabet. When a name is saved in the mobile device, an additional string is generated and saved along with the name. This string contains a character for each letter of the name that is saved. These characters represent the input points that correspond to the subset of the alphabet containing that letter. When it is desired to retrieve the name, the database is searched using the characters representing the input points selected by the user, for example, rather than searched using the multiple characters in the subset of the alphabet that correspond to that input point.

Exemplary Computing Environment

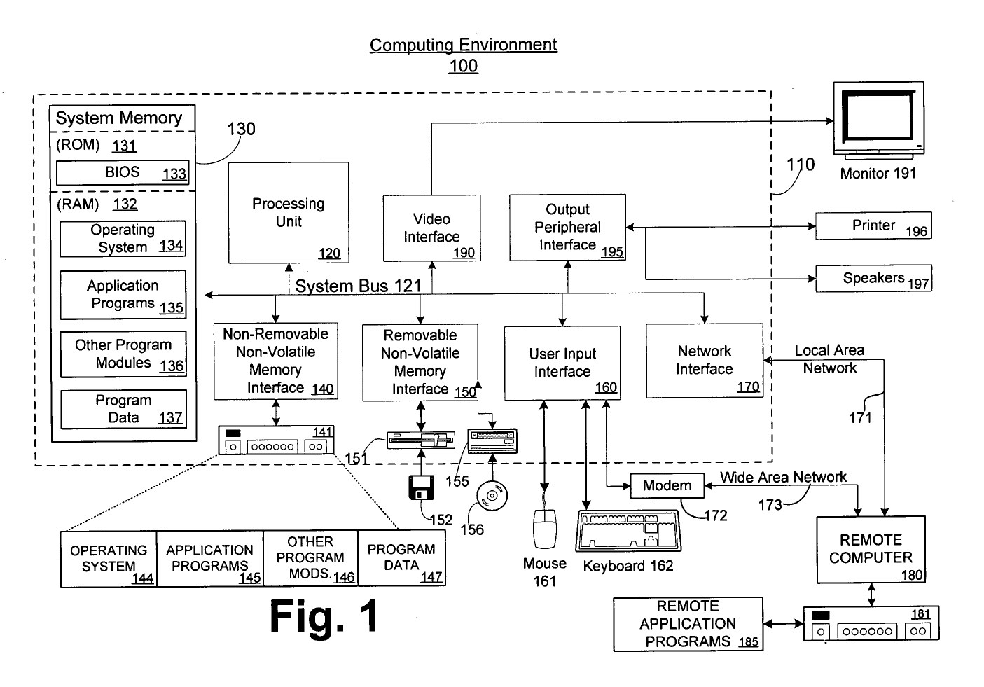

FIG. 1 illustrates an example of a suitable computing system environment 100 in which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network or other data transmission medium. In a distributed computing environment, program modules and other data may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or non-volatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/non-volatile computer storage media. By way of example only, FIG. 1 illustrates a hard disk drive 140 that reads from or writes to non-removable, non-volatile magnetic media, a magnetic disk drive 151 that reads from or writes to a removable, non-volatile magnetic disk 152, and an optical disk drive 155 that reads from or writes to a removable, non-volatile optical disk 156, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted include a LAN 171 and a WAN 173, but may also include other networks. Such networking environments are commonplace in offices, enterprise-wide computer networks, intranets and the internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Exemplary Distributed Computing Frameworks Or Architectures

Various distributed computing frameworks have been and are being developed in light of the convergence of personal computing and the internet. Individuals and business users alike are provided with a seamlessly interoperable and web-enabled interface for applications and computing devices, making computing activities increasingly web browser or network-oriented.

For example, MICROSOFT®'s .NET platform includes servers, building-block services, such as web-based data storage, and downloadable device software. Generally speaking, the NET platform provides (1) the ability to make the entire range of computing devices work together and to have user information automatically updated and synchronized on all of them, (2) increased interactive capability for websites, enabled by greater use of XML rather than HTML, (3) online services that feature customized access and delivery of products and services to the user from a central starting point for the management of various applications, such as e-mail, for example, or software, such as MICROSOFT®'s Office, (4) centralized data storage, which will increase efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors, and (7) many other cross-platform integration features as well.

While exemplary embodiments herein are described in connection with software residing on a computing device, one or more portions of the invention may also be implemented via an operating system, API, or a “middle man” object between a coprocessor and requesting object, such that services may be performed by, supported in, or accessed via all of NET's languages and services, and in other distributed computing frameworks as well.

### Exemplary Embodiments

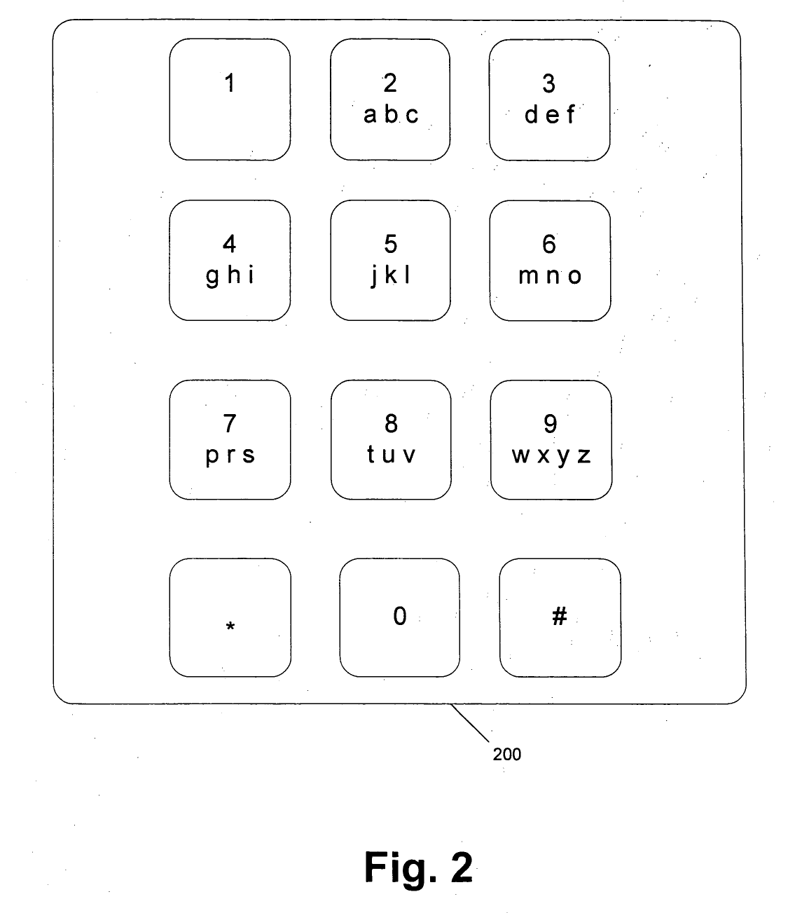

FIG. 2 is an example of a input device (“keypad 200”) in accordance with the present invention. It is appreciated that any method, technique, or system known in the art for data entry may be used. In the present embodiment keypad 200 may be a standard twelve key keypad well known in the art, commonly used on touch tone telephones.

In an exemplary embodiment, each of the first nine keys, except for the first key, corresponds to a subset of the alphabet. For example, key 2 corresponds to letters a, b, and c. Key 3 corresponds to letters d, e, and f. Key 4 corresponds to letters g, h, and i. Key 5 corresponds to letters j, k, and 1. Key 6 corresponds to letters m, n, and o. Key 7 corresponds to letters p, r, and s. Key 8 corresponds to letters t, u, and v. Key 9 corresponds to letters w, x, y, and z. A user selects a letter by depressing a key a corresponding number of times. To enter the letter ‘b’ for example, the user would depress key 2 twice. To select the letter ‘c’, the user would depress key 2 three times.

Keypad 200 may reside, for example, on a mobile telephone, or other device, such as a personal digital assistant (PDA). The keypad 200 may be used for dialing a telephone, for sending a small messaging system type message, or for any other use involving the input of characters.

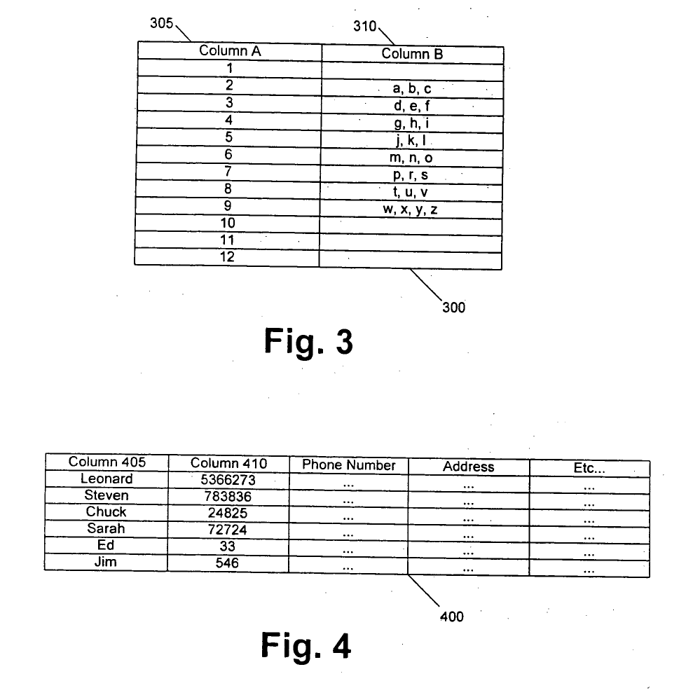

FIG. 3 is a sample table (“table 300”) for associating characters on a keypad with subsets of the alphabet in accordance with the present invention. As shown in this example, table 300 comprises two columns 305, 310 (which are also referred to as columns A and B, respectively), and a row for each of the keys on keypad 200. Keys 10, 11, and 12 correspond to the keys labeled ‘*’, ‘0’, and ‘#’, respectively, in FIG. 2. In column 305 (“column A”) there is a row entry containing a unique character associated with each key. For example, key 2 may be represented by the character ‘2’. In column 310 (“column B”), there is a corresponding row entry containing characters representing the subset of the alphabet corresponding to each key entry. For example, as shown, in the row for key 2 at column B, there may be the characters ‘a’, ‘b’, and ‘c’. The table 300 is used for locating the key on keypad 200 representing a given character. Although the data in FIG. 3 is shown in table form, it is contemplated that any storage device or structure could be used to store the characters.

FIG. 4 is a sample table (“table 400”) for storage of records or contacts or other information in accordance with the present invention. It is appreciated that any method, technique, or system known in the art for data storage may be used. In the embodiment shown, each row of the table represents an individual record or contact. Each column in the table represents a piece of information associated with a particular contact. For example, there are at least two columns for each record. In one column 405, there may be the string representing the name of the contact. For example, “Steven” may be stored for a contact named Steven. In another column 410, there may be the string representing the keys on keypad 200 associated with the string in column 405. For example, “783836” may be stored in column 410 for a contact named Steven in column 405. The table 400 is desirably used for the storage of a phonebook or contacts list of a mobile phone user. A user would input the data, or otherwise import the data, into the storage.

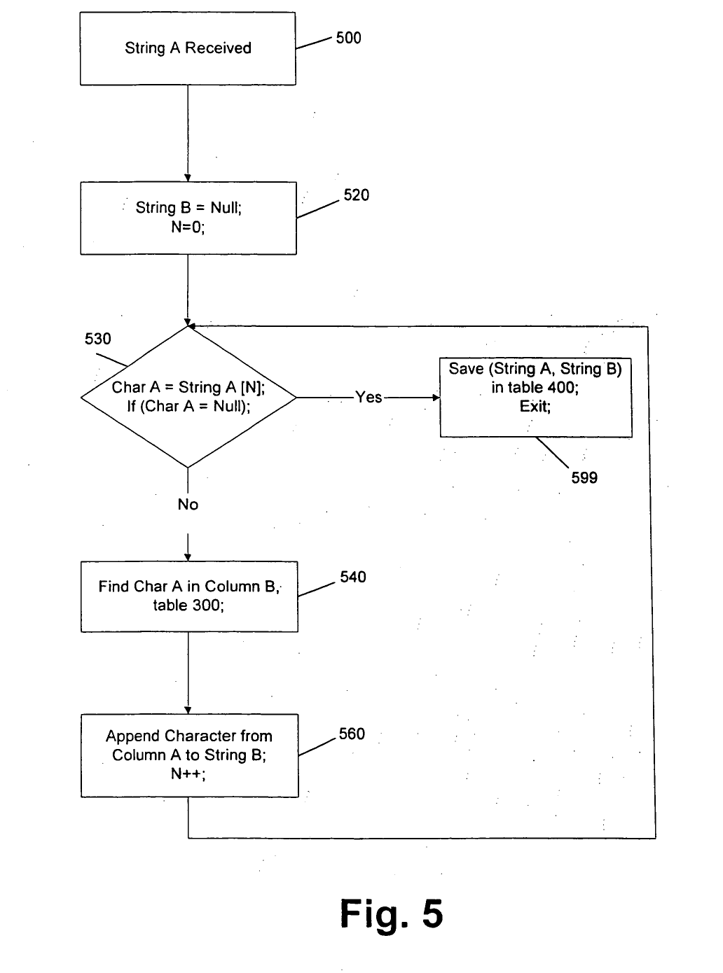

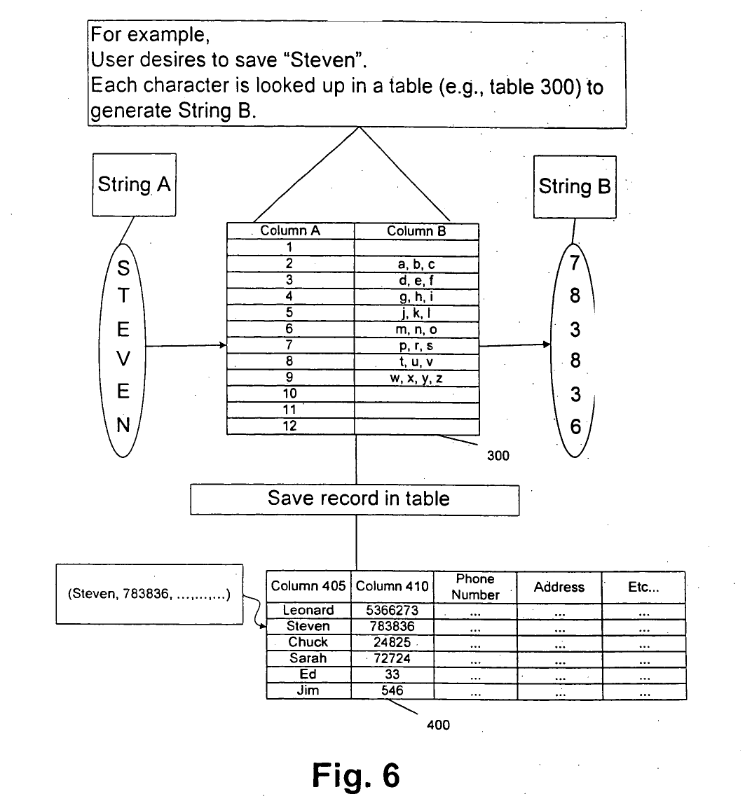

FIG. 5 is a flow diagram of an exemplary method of submitting a record or string in accordance with the present invention. In this exemplary embodiment, as described in further detail below, a string is received, a new string is generated from that string through a mapping function, and the resulting string is stored along with the original string. FIG. 6 provides a specific example using the exemplary method of FIG. 5.

At step 500, the application receives a string “String A” to store. In the exemplary embodiment this string may be received through keypad 200. It is appreciated that any size keypad may be used, along with any size alphabet, so long as there is a less than 1 to 1 mapping of keys to letters. The string may also be received, for example, from another user through an infrared device or a small messaging system text message. For example, as will be further described with respect to FIG. 6, assume that a user desires to save the string “Steven”, which is received through keypad 200 to store.

At step 520, an empty or “null” string (“String B”), may be created to hold the mapped value of String A. An integer counter (“N”) may also be created to track the current character in String A. The value of N may be set to zero. It is appreciated that any method, technique, or system known in the art for tracking the current position in a string, such as a pointer, may be used.

At step 530, the character at position N in String A is examined. If the character is “null”, signifying the end of the string, processing continues at step 599. If the character is not “null”, the character (“Char A”) is saved and processing continues at step 540. It is appreciated that any method, technique, or system known in the art for manipulating strings may be used.

At step 540, the corresponding keypad 200 character to Char A is determined. Char A may be located in table 300, in column B, at some row (“Row A”), for example. In the present embodiment, table 300 provides a mapping from every letter in the alphabet to a corresponding character representing a key on the keypad. It is appreciated that any method, technique, or system known in the art for associating a character with another character can be used.

At step 560, the character associated with Char A (e.g., the character in column A, Row A) is selected and appended to String B. This has the effect of adding the character associated with Char A in table 300 to String B. In addition, the value of N is increased by one. This has the effect of moving one character forward in String A. It is appreciated that any method, technique, or system known in the art for manipulating strings can be used. The embodiment may now return to step 530. Steps 530-560 may repeat until each character in String A has been examined.

An example embodying steps 510-560 is further illustrated in FIG. 6. In this example, each character in “Steven” may be looked up in table 300 to find the corresponding key on keypad 200. In this example, ‘S’ corresponds to key 7 on keypad 200, ‘T’ corresponds to key 8 on keypad 200, ‘E’ corresponds to key 3 on keypad 200, ‘V’ corresponds to key 8 on keypad 200, ‘E’ corresponds to key 3 on keypad 200, and ‘N’ corresponds to key 6 on keypad 200. String B may then be computed by appending the resulting characters together. The resulting value of String B is “783836”.

Step 599 is reached when all characters in String A have been examined and a corresponding String B has been generated. At step 599, String B and String A may now be saved together, for example, in table such as table 400. It is appreciated that any method, technique, or system known in the art for storing strings can be used. Thus, table 400 now contains a new record comprising String A and String B.

Step 599 is further illustrated with respect to FIG. 6. In this example, the strings “783836” and “Steven” are now saved together, along with any additional contact information that the user may wish to associate with “Steven”, as a record (for example, in a table such as in table 400). It is appreciated that saving “783836”, along with the name “Steven” will allow the user to quickly retrieve the record later by prefix searching on the value of the key pressed, rather than multiple prefix searches using the set of characters the key represents.

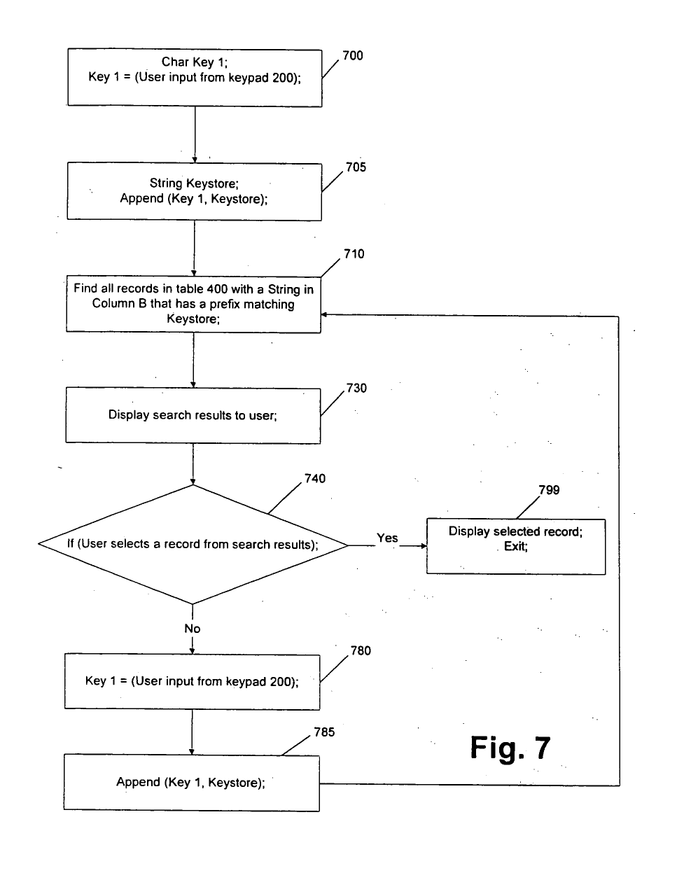

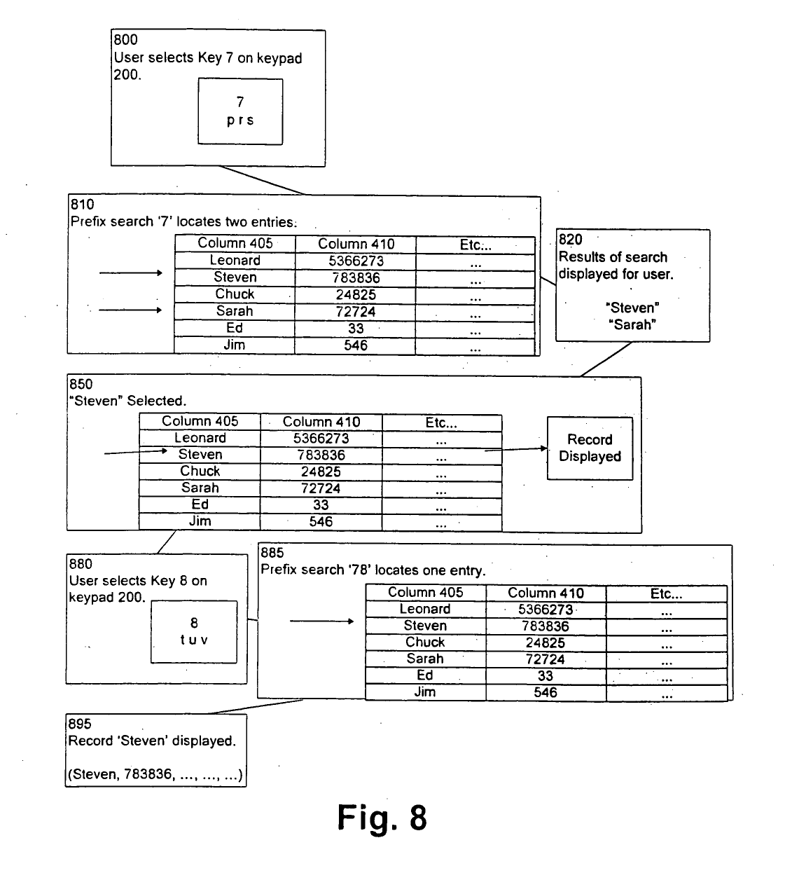

FIG. 7 is a flow diagram of an exemplary method of retrieving a record or string from storage such as a database in accordance with the present invention. In this exemplary embodiment, as described in further detail below, a user desires to locate a particular record using a string, and enters the first character of that string, a prefix search of that string is performed on a database, and matching records are retrieved from the database and presented to the user. The user either selects the desired record or submits the next character of the string to further narrow the results. FIG. 8 provides a specific example using the method of FIG. 7 to locate the record associated with the name “Steven”.

At step 700, the user may press the key representing the first character of the string (“String A”) associated with the record that the user desires to locate. In an exemplary embodiment, this key may be located on keypad 200. A variable (“Key 1”) may be created and may be set to the value of the key pressed by the user. It is appreciated that any size keypad can be used, along With any size alphabet, so long as there is a less than 1 to 1 mapping of keys to letters.

This step is further illustrated at box 800 in FIG. 8. The user desires to locate the record associated with the name “Steven.” The user may press key 7, corresponding to “prs” on keypad 200, as ‘s’ is the first character of “Steven.”

At step 705, a string may be created (“Keystore”) to contain the current value of the string associated with the record that the user desires to locate. Key 1 may now be appended to Keystore. The string append operations may be done using any method, technique, or system known in the art for taking a string and adding another string to the end of it.

At step 710, a prefix search of Keystore may be performed on column 410 of table 400, or on another storage system that may be used to store the information. The prefix search may find all strings in column 410 of table 400 that have Keystore as a prefix. The prefix search may be done using any method, technique, or system known in the art for taking a string and locating all strings containing that string as a prefix.

This step is further illustrated at 810. In this example, a prefix search of ‘7’ may be performed in column 410 of table 400. The prefix search may find all strings in column 410 of table 400 that begin with ‘7’. In this example, the search will have located “783836”, and “72724”. These correspond to the entries of “Steven” and “Sarah” respectively. It may be appreciated that prefix searching column 410 for ‘7’ is more efficient than the prior art methods of three separate prefix searches for the characters ‘p’, ‘r’, and ‘s’ on column 405.

At step 730, the strings values in column 405 associated by row in table 400 with the values in column 410 found in the prefix search may be displayed for the user. It is appreciated that the display of the located strings can be done using any method, technique, or system known in the art for presenting values to a user for selection.

Step 730 is further illustrated at box 820. The located strings “Steven” and “Sarah” may be displayed for the user.

At step 740, the user either selects one of the displayed strings, or continues to enter additional characters of String A to narrow the search. It is appreciated that often there will be few matching strings found, and in that case it may be easier for the user to directly select the desired string from the presented list. However, if the search returns a large number of matching strings, it may be easier for the user to continue to enter characters of String A to avoid moving through the large list of strings. If the user selects a record from the list, processing continues to step 799; otherwise, processing proceeds at step 780.

At step 799, the user has already selected the desired string from the list of matching strings. In the exemplary embodiment, this string may represent a name or address. The record corresponding to the selected string may now be returned or displayed for the user. In the exemplary embodiment, this may be done by retrieving the data found in each of the columns associated with the row containing the selected string. This data may represent phone numbers, names, addresses, or any other values that may be associated with a contact. It is appreciated that any method, technique, or system known in the art for locating and displaying a record may be used.

Step 799 is further illustrated with respect to box 850. There the user has selected “Steven” from the list of matching strings. The record corresponding to “Steven” may now be returned or displayed for the user.

At step 780, the user may press the key representing the next character of the String A associated with the record that the user desires to locate. The value of the key selected may now be saved in Key 1. In the exemplary embodiment, this key may be located on keypad 200. It is appreciated that any size keypad can be used, along any size alphabet, so long as there is a less than 1 to 1 mapping of keys to letters.

Step 780 is further illustrated with respect to box 880. In this example, the user has already searched for the record associated with the name “Steven” using a prefix search of ‘7’. The user now desires to further narrow that search by entering the next character of “Steven.” The user may now press key 8, corresponding to “tuv” on keypad 200, as ‘t’ is the second character of “Steven.”

At step 785, Key 1 may now be appended to Keystore. The string append operations may be done using any method, technique, or system known in the art for taking a string and adding another string to the end of it. The process may then return to step 710.

The exemplary method shown in FIG. 7 will repeat between steps 710 and 785 for each character entered by the user; however, the example illustrated in FIG. 8 terminates after the second prefix search. In the example illustrated at 885, a prefix search of “78” may be performed in column 410 of table 400. This prefix represents the first and second keys pressed when the user enters the string “Steven.” The prefix search will find all strings in column 410 of table 400 that have a first character ‘7’, and a second character ‘8’. The prefix search may be done using any method, technique, or system known in the art for taking a string and locating all strings containing that string as a prefix. It may be appreciated that prefix searching column 410 for ‘78’ is more efficient than the prior art methods of nine separate prefix searches in column 405 for the strings “pt”, “pu”, “pv”, “rt”, “st”, “su”, and “sv”. Theses searches represent all possible permutations of the strings represented by keys 7 and 8.

At box 895, the located string “Steven” may be displayed for the user. “Steven” is the only matching string found, and the record corresponding to the selected string may now be returned or displayed for the user. The display may be done by retrieving the data found in each of the columns associated with the row in table 400 that contain “Steven”. The record may contain phone numbers, names, addresses, or any other values that may be associated with a contact. It is appreciated that any method, technique, or system known in the art for locating and displaying a record may be used.

As mentioned above, while exemplary embodiments of the present invention have been described in connection with various computing devices, the underlying concepts may be applied to any computing device or system.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

While the present invention has been described in connection with the preferred embodiments of the various figures, it is to be understood that other similar embodiments may be used or modifications and additions may be made to the described embodiments for performing the same function of the present invention without deviating therefrom. Therefore, the present invention should not be limited to any single embodiment, but rather should be construed in breadth and scope in accordance with the appended claims.

1. A method for searching data in an electronic device comprising:
storing a plurality of first character strings and corresponding second character strings;
receiving a query; and
searching the stored character strings responsive to the query by receiving a character, appending said character to previously received characters if any, performing a prefix search of received characters on the stored second character strings, and returning a set of first character strings stored with the second character strings that match the prefix search.

2. The method of claim 1, further comprising receiving one of the first character strings, and generating the corresponding second character string.

3. The method of claim 2, wherein the receiving the first character string comprises:
(A) receiving an input character;
(B) appending said input character to previously received input characters if any;
(C) repeating steps (A) and (B) for each additional character received.

4. The method of claim 2, wherein generating the second character string comprises:
mapping a first set of characters to a second set of characters; and
building the second character string from the second set of characters using the mapping and the first character string.

5. The method of claim 4, wherein each of the characters in the second set of characters corresponds to an input point on an input device, and each of the characters in the first set of characters corresponds to a letter of an alphabet.

6. The method of claim 4, further comprising storing the mapping as a table.

7. The method of claim 6, wherein the storing as a table comprises:
storing each of the characters in the second set of characters in a respective row in a first column of the table; and
storing an associated subset of characters of the first set of characters in a respective row in a second column of the table.

8. The method of claim 1, wherein receiving the character comprises:
receiving input from an input device; and
determining the character from a set of characters that corresponds to the received input.

9. The method of claim 8, wherein the input device comprises a plurality of input points, wherein each input point corresponds to a unique subset of an alphabet.

10. The method of claim 1, further comprising repeating the steps of appending, performing a prefix search, and returning the set, in response to receiving a further character.

11. The method of claim 1, wherein returning the set of first character strings comprises displaying the set of first character strings corresponding to the second character strings that match the prefix search on a display device.

12. The method of claim 11, further comprising:
receiving a first character string selection of the set of first character strings shown on the display device; and
displaying the set of character strings stored with the first character string selection on a display device.

13. A computer-readable medium having stored thereon computer-executable instructions for performing a method for searching data in an electronic device comprising:
storing a plurality of first character strings and corresponding second character strings;
receiving a query; and
searching the stored character strings responsive to the query by receiving a character, appending said character to previously received characters if any, performing a prefix search of received characters on the stored second character strings, and returning a set of first character strings stored with the second character strings that match the prefix search.

14. The computer-readable medium of claim 13, further comprising computer-executable instructions for receiving one of the first character strings, and generating the corresponding second character string.

15. The computer-readable medium of claim 14, wherein the receiving the first character string comprises computer-executable instructions for:
(A) receiving an input character;
(B) appending said input character to previously received input characters if any;
(C) repeating steps (A) and (B) for each additional character received.

16. The computer-readable medium of claim 14, wherein generating the second character string comprises computer-executable instructions for:
mapping from a first set of characters to a second set of characters; and
building the second character string from the second set of characters using the mapping and the first character string.

17. The computer-readable medium of claim 16, wherein each of the characters in the second set of characters corresponds to an input point on an input device, and each of the characters in the first set of characters corresponds to a letter of an alphabet.

18. The computer-readable medium of claim 16, further comprising computer-executable instructions for storing the mapping as a table.

19. The computer-readable medium of claim 18, wherein the storing as a table comprises computer-executable instructions for:
storing each of the characters in the second set of characters in a respective row in a first column of the table; and
storing an associated subset of characters of the first set of characters in a respective row in a second column of the table.

20. The computer-readable medium of claim 13, wherein receiving the character comprises computer-executable instructions for:
receiving input from an input device; and
determining the character from a set of characters that corresponds to the received input.

21. The computer-readable medium of claim 20, wherein the input device comprises a plurality of input points, wherein each input point corresponds to a unique subset of an alphabet.

22. The computer-readable medium of claim 13, further comprising computer-executable instructions for repeating the steps of appending, performing a prefix search, and returning the set, in response to receiving a further character.

23. The computer-readable medium of claim 13, wherein returning the set of character strings comprises displaying the set of first character strings corresponding to the second character strings that match the prefix search on a display device.

24. The computer-readable medium of claim 23, further comprising computer-executable instructions for:
receiving a first character string selection of the set of first character strings shown on the display device; and
displaying the set of character strings stored with the first character string selection on a display device.

25. A data searching system, comprising:
a storage device for storing a plurality of first character strings and corresponding second character strings;
an input device for receiving a query;
a display device for displaying a set of character strings; and
a processor for searching the stored character strings responsive to the query by receiving a character, appending said character to previously received characters if any, performing a prefix search of received characters on the stored second character strings, and providing to the display a set of character strings stored with the second character strings that match the prefix search.

26. The system of claim 25, wherein the processor receives the first character strings from the input device, and generates the second character strings corresponding to the first character strings.

27. The system of claim 26, wherein the processor is adapted to receive the first character string by (A) receiving an input character; (B) appending said input character to previously received input characters if any; and (C) repeating steps (A) and (B) for each additional character received.

28. The system of claim 26, wherein the processor generates the second character strings by mapping a first set of characters to a second set of characters, and building the second character string from the second set of characters using the mapping and the first character string.

29. The system of claim 28, wherein each of the characters in the second set of characters corresponds to an input point on the input device, and each of the characters in the first set of characters corresponds to a letter of an alphabet.

30. The system of claim 28, wherein the storage device comprises a table for storing the mapping.

31. The system of claim 30, wherein the table comprises:
a respective row in a first column of the table for storing each of the characters in the second set of characters; and
a respective row in a second column of the table for storing an associated subset of characters of the first set of characters.

32. The system of claim 25, wherein the processor determines the character from a set of characters that corresponds to the received input.

33. The system of claim 25, wherein the input device comprises a plurality of input points, wherein each input point corresponds to a unique subset of an alphabet.

34. The system of claim 25, wherein the processor repeats the steps of appending, performing a prefix search, and returning the set, in response to receiving a further character.

35. The system of claim 25, wherein the display device displays the set of first character strings corresponding to the second character strings that match the prefix search.

36. The system of claim 35, wherein the input device receives a first character string selection of the set of first character strings shown on the display device, and the display device displays the set of character strings stored with the first character string selection.
